(19) United States
(12) Patent Application Publication
(10) Pub. No.: US 2004/0246236 A1
(43) Pub. Date: Dec. 9, 2004

(54) REMOTE CONTROL FOR ELECTRONIC WHITEBOARD

(75) Inventors: Peter Hildebrandt, Duluth, GA (US); James D. Watson, Duluth, GA (US); Neal A. Hofmann, Atlanta, GA (US); A. Joel Assaraf, Douglasville, GA (US); Michael H. Dunn, Dunwoody, GA (US); Ian G. Hutchinson, Suwanee, GA (US); Gregg Draudt, Stow, MA (US); Sam Millen, Concord, MA (US)

Correspondence Address: TROUTMAN SANDERS LLP, BANK OF AMERICA PLAZA, SUITE 5200, 600 PEACHTREE STREET, NE, ATLANTA, GA, 30308-2216, US

(73) Assignee: Greensteel, Inc., Norcross, GA (US)

(21) Appl. No.: 10/453,054

(22) Filed: Jun. 2, 2003

(51) Int. Cl. G09G 5/00

(52) U.S. Cl. 345/169

(57) ABSTRACT

### Abstract of the Disclosure

A remote controllable electronic whiteboard system and method of operating the remote controllable electronic whiteboard system are provided. An exemplary remote controllable electronic whiteboard system includes an electronic whiteboard in communication with a remote control device. Methods of operating the electronic whiteboard system including the use of a remote control device are also provided.

### Detailed Description of the Invention

### Background of the Invention

1.Field of the Invention

The present invention is directed to methods of operating visual communication systems, more particularly, to remote controllable whiteboard systems and methods of their operation.

2.Description of Related Art

Electronic whiteboard systems are rapidly becoming essential tools in education and conferencing. Writing or drawing on electronic whiteboards during lectures or presentations can be captured, saved, manipulated, processed and printed using these systems. Ideas during brainstorming sessions can be preserved and recorded for further evaluation or implementation without the need of further transcribing the information. The convenience and ability to reach participants using networked systems makes the use of electronic whiteboard systems very attractive.

Popular electronic whiteboard systems include touch sensitive surfaces on the electronic whiteboard allowing a user to operate an attached computer simply by touching an image projected on the touch sensitive surface. Thus, in addition to controlling the operation of the electronic whiteboard system from an attached computer, the user can operate the computer while the user is at the electronic whiteboard and while addressing an audience from the electronic whiteboard. Although operating electronic whiteboard systems from a touch sensitive surface of the electronic whiteboard allows the user to operate the system while addressing an audience, current electronic systems require the user to physically input instructions near the surface of the electronic whiteboard or near the terminal of an attached computer. Restricting the location of a user to these areas can be a disadvantage especially to educators that must be able to move freely about a room or audience while maintaining the ability to operate the electronic whiteboard system.

Additionally, current electronic whiteboard systems employ complex software applications or operating systems that can confuse new or infrequent users and clutter available electronic whiteboard space with windows, icons, multiple tool box menus or pop-up menus for controlling or navigating a software application running on the electronic whiteboard system. Such excessive tool box menus or pop-up menus restrict the available area of the projected display on an electronic whiteboard for use during a lecture or presentation. Additionally, these complex operating systems can require specialized training before a user can effectively use the electronic whiteboard system. Additionally, users must move between the computer screen and the electronic whiteboard to perform commands, click ok buttons, and type in filenames for saving snapshots (captures) of the ink on the board or projected images with electronic ink markups.

Thus, there is a need for electronic whiteboard systems and methods for operating electronic whiteboard systems that permit a user to move about a room or audience while still maintaining the ability to operate the electronic whiteboard system and computer from any position, preferably positions away from the electronic whiteboard or associated computer.

There is another need for remote controllable electronic whiteboard systems and methods of operating these systems.

There is still another need for remote controllable electronic whiteboard systems that operate without excessive pop-up menus and projected tool box menu.

### Brief Summary of the Invention

Aspects of the present invention provide visual communication systems and methods of operating visual communication systems. Visual communication systems can include among others, whiteboards, blackboards, and electronic whiteboards. The disclosed remote controllable electronic whiteboard systems can enable a user to operate the electronic whiteboard systems from locations remote from or distal both the surface of the electronic whiteboard and an attached computer terminal. Thus, the user has a greater range of mobility while maintaining the ability to operate the electronic whiteboard system.

Using a remote control device in combination with input from the surface of an electronic whiteboard or from an attached computer terminal to operate the disclosed electronic whiteboard systems reduces the need for multiple menus or icons projected on the surface of the electronic whiteboard. In some aspects of the present invention, a remote control device can be used to activate various control areas that can modify the function of the electronic whiteboard system. For example, the remote control device can be used to toggle between command modes when a user is working with a projected image or physically writing or drawing on the electronic whiteboard directly. Alternatively, the remote control device can be used to save data written or projected on an electronic whiteboard, or a combination of written and projected data.

One aspect of the present invention provides a remote control device for an electronic whiteboard system having a body portion with a transmitting device for transmitting a signal to the electronic whiteboard system. The remote control device also can include at least one actuator that when selected, triggers the transmission of a signal to the electronic whiteboard system for remotely controlling an operation of the electronic whiteboard system. The electronic whiteboard system further can include a receiving device for receiving a signal from the remote control. The receiving device can be in communication with the electronic whiteboard system, a component thereof, or a combination of components thereof, or attached to the computer.

Another aspect of the present invention provides an electronic whiteboard system having an electronic whiteboard operatively connected to a processing device, and a remote control device for transmitting a signal to the electronic whiteboard. The signal causes a set of instructions to be executed by the electronic whiteboard system. The system can also have a receiving device operatively connected to the electronic whiteboard for receiving a signal from the remote control. When the system executes the set of instructions, a function of the system is altered, initiated, terminated, modified or otherwise affected.

Still another aspect of the invention provides an electronic whiteboard system having an electronic whiteboard in communication with a computing device, wherein the computing device is operatively connected to a display device. The system also has a projection device in communication with the computing device for projecting an image onto a surface of the electronic whiteboard. A receiving device for receiving a signal from a remote control device is also included and is in communication with the electronic whiteboard.

An exemplary method of operating electronic whiteboard systems includes receiving a signal from a remote control device, and executing a set of instructions in response to receiving the signal, wherein the set of instructions alters a function of the electronic whiteboard system. Signals can also be received from the electronic whiteboard surface or attached computer. Thus, another aspect provides a method of operating an electronic whiteboard system by receiving signals from a remote control device and the surface of an electronic whiteboard or its associated computer device. Another exemplary method of operating remote controllable whiteboard systems includes the steps of receiving a signal from a remote control device, and executing a set of instructions in response to receiving the signal, wherein the set of instructions alters an image displayed on a surface of the electronic whiteboard.

Other advantages and aspects of the present invention can be understood from the appended drawings and accompanying description.

### Brief Description of the Drawings

Figure 1 depicts an exemplary electronic whiteboard system.

Figure 2 depicts an exemplary processing device of the present invention.

Figure 3 is an flow diagram of an exemplary method of operating an electronic whiteboard system.

Figures 4A and 4B are diagrams of an exemplary remote control for an electronic whiteboard system.

Figures 5A and 5B are top and bottom views of an interior component of an exemplary remote control for an electronic whiteboard system.

Figures 6A and 6B are diagrams of an exemplary mounting bracket for a remote control for an electronic whiteboard system.

Figure 7 illustrates where a remote control device can be placed at a number of locations along an edge of the electronic whiteboard on a mounting bracket.

Figures 8A and 8B illustrate a locking mechanism for a remote control device.

### Detailed Description of the Invention

The use of electronic whiteboard systems, for example in conferencing and education, provides a convenient and powerful tool for communicating ideas to individuals or groups of individuals. Typical electronic whiteboard systems restrict the operation of the whiteboard systems to the surface of the electronic whiteboards or to a computer terminal connected to the electronic whiteboard. As a result of this limitation, a user cannot move away from the surface of the electronic whiteboard or computer and still control the operation of the electronic whiteboard system. One embodiment of the present invention overcomes this and other limitations of existing electronic whiteboard systems by incorporating remote control functionality into electronic whiteboard systems. The inclusion of remote control functionality into electronic whiteboard systems enable a user to operate the electronic whiteboard system from a variety of locations distal the whiteboard and/or computer, yet does not foreclose a user to operate the system from the surface of the electronic whiteboard or from a computer attached to the electronic whiteboard.

Electronic Whiteboard Systems

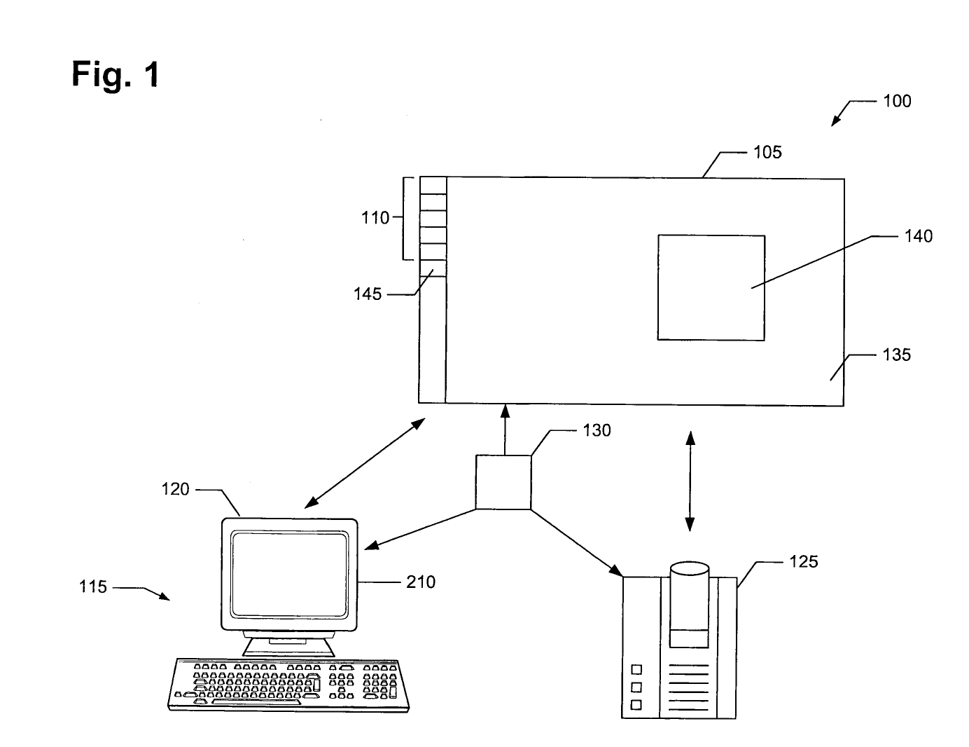

Fig. 1 depicts an exemplary electronic whiteboard system 100 of the present invention. The electronic whiteboard system 100 includes an electronic whiteboard 105 operatively connected to a processing device 115. Processing device 115 can be an integrated component of the electronic whiteboard, or processing device 115 can be an external component. Suitable processing devices include computing devices 210 such as personal computers.

Electronic whiteboards 105 are known in the art and can receive input from a user in a variety of ways. For example, electronic whiteboards 105 can incorporate capacitance technology and receive input from a user via an electrically conductive stylus. The stylus can be a writing implement including a finger. An exemplary stylus can transmit a signal to electronic whiteboard 105 indicating the location of the stylus in relation to a surface of electronic whiteboard 105. The stylus can also transmit other information to electronic whiteboard 105 including but not limited to pen color, draw or erase mode, line width, font or other formatting information.

In another embodiment, electronic whiteboard 105 can be touch sensitive or pressure sensitive. Touch sensitive or pressure sensitive means having the capability to convert a physical contact into an electrical signal or input. Touch sensitive electronic whiteboards can incorporate resistive membrane technology. See for example U.S. Patent No. 5,790,114 to Geaghan et al. describing resistive membrane electronic whiteboards, and which patent is incorporated herein in its entirety.

In one embodiment, electronic whiteboard 105 has two conductive sheets physically separated from one another, for example by tension, such that the two sheets contact each other in response to a touch or physical pressure. The sheets are made of a conductive material or can be coated with a conductive material such as a conductive film, and can be deformable. Touching, writing, or other application of pressure on the surface of the conductive sheets causes contact between the two conductive sheets resulting in a detectable change in voltage or resistance. The sheets can act as resistance dividers and a voltage gradient can be created by applying different voltages at the edges of a sheet. The change in voltage or resistance can then be correlated to a location value, for example a Cartesian coordinate set. Coordinate data, for example (x,y) pairs or their equivalent, can be transmitted to processing device 115 in compatible data packets, for processing, manipulating, editing, or storing.

Other embodiments for an electronic whiteboard 105 include laser-tracking, electromagnetic, infrared, camera-based systems, and so forth. These systems detect the presence of ink markings or a pointer or stylus device across a two-dimensional surface, which may be enabled for erasure of marks made with a dry-erase maker, but do not have to be.

Conventional dry-erase markers are typically used to write on a surface of electronic whiteboard 105, but any erasable or removable ink, pigment, or coloring can be used to physically mark a surface of electronic whiteboard 105. The physical markings on electronic whiteboard 105 can be removed using conventional methods including an eraser, towel, tissue, hand, or other object that physically removes the markings from the surface of electronic whiteboard 105.

Electronic whiteboard 105 can also include a control area 110, although use of the remote control device 130 can make such an area duplicative. Control area 110 can contain multiple control areas 145 (for example a button or a soft key) for controlling a function of the electronic whiteboard system 100. Control area 110 can be an actuator, for example a physical button 145, that can be actuated by applying pressure to control area 110. The function of control area 110 can be fixed or variable. If the function of control area 110 is variable, control area 110 can comprise a soft key 145 whose function can be controlled by processing device 115. For example, soft key 145 can have different functions depending on different application software running on processing device 115. An image or icon can be projected near control area 110 indicating the current function of a soft key 145 using a projecting device 125.

Projecting device 125 can be operatively connected to processing device 115, whiteboard 105, or both. Projecting device 125 can be a conventional projecting device for projecting a graphical user interface typically on a display 120 of the processing device 115 onto a surface 135 of the electronic whiteboard 105. Projecting device 125 can adjust for image distortions including keystoning and other optical problems, for example optical problems arising from the alignment of a projected image on surface 135 with the graphical user interface on display 120. Alternatively, processing device 115 can adjust for image or alignment problems. A user can also physically adjust projecting device 125 to compensate for image problems including keystoning.

Another embodiment of the present invention includes a plasma display or rear-projection system with a coordinate-detecting surface, such as a touch-sensitive, capacitive, camera-based, laser-tracking, electromagnetic, or others, whereby a stylus can be tracked on the surface and the video source is provided by the processing device 115.

Electronic whiteboard system 100 can also include remote control device 130 that can be in communication with the electronic whiteboard system 100, or a component thereof. For example, remote control device 130 can be in communication with electronic whiteboard 105, processing device 115, projecting device 125, or a combination thereof. Communication between remote control device 130 and another component of the system 100 can be by electromagnetic technology, including, but not limited to, infrared or laser technology. Additionally, communication between remote control device 130 and electronic whiteboard system 100 can be by conventional wireless, radio, or satellite technology.

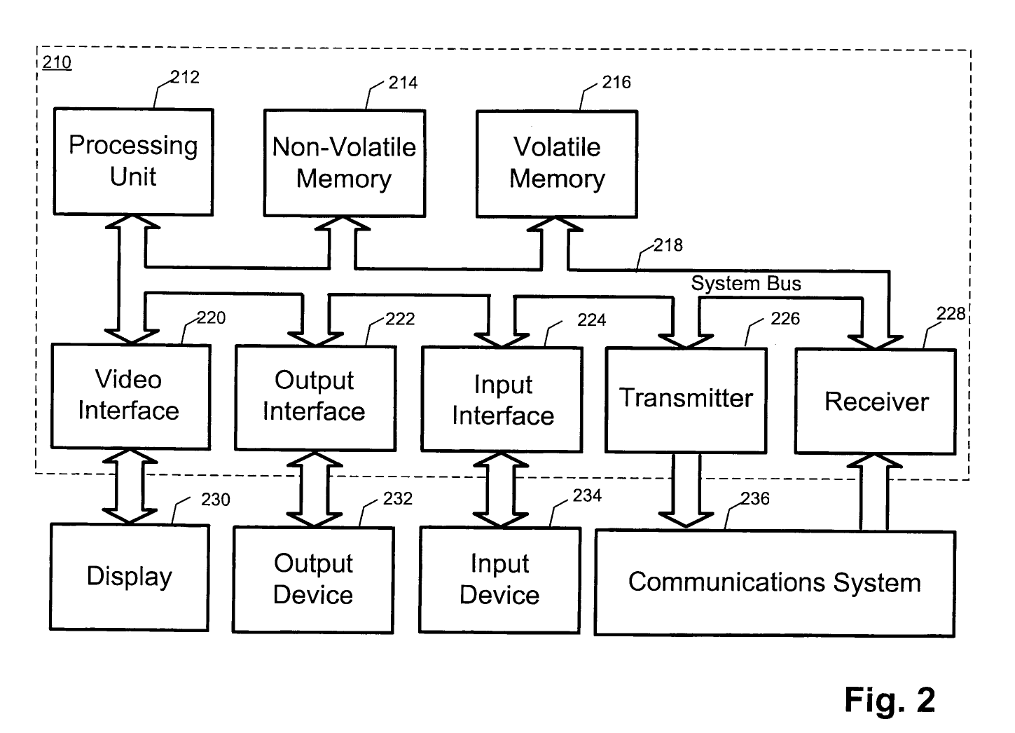

Fig. 2 is a diagram of an exemplary processing device of the present invention. Fig. 2 and the following discussion provide a general overview of a platform onto which the invention may be integrated or implemented.

Those skilled in the art will appreciate that the system illustrated in Fig. 2 may take on many forms and may be directed towards performing a variety of functions. Generally, the system illustrated in Fig. 2 is a system that includes a receiving device. Examples of such forms and functions include, but are not limited to, cellular telephones, radio telephones, portable telephones, two-way pagers, personal computers, hand-held devices such as personal data assistants and calculators, consumer electronics, note-book computers, lap-top computers, radios, televisions, satellite receivers, and a variety of other applications, each of which may serve as an exemplary environment for embodiments of the present invention.

The exemplary system illustrated in Fig. 2 includes a processing device 115, such as computing device 210, that is made up of various components including, but not limited to, a processing unit 212, non-volatile memory 214, volatile memory 216, and a system bus 218 that couples the non-volatile memory 214 and volatile memory 216 to the processing unit 212. The non-volatile memory 214 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 214 provides storage for power on and reset routines (bootstrap routines) that are invoked upon applying power or resetting the computing device 210. In some configurations the non-volatile memory 214 provides the basic input/output system (BIOS) routines that are utilized to perform the transfer of information between elements within the various components of the computing device 210.

The volatile memory 216 may include, a variety of memory types and devices including, but not limited to, random access memory (RAM), dynamic random access memory (DRAM), FLASH memory, EEPROM, bubble memory, registers, or the like. The volatile memory 216 provides temporary storage for routines, modules, functions, macros, data etc. that are being or may be executed by, or are being accessed or modified by the processing unit 212. In general, the distinction between non-volatile memory 214 and volatile memory 216 is that when power is removed from the computing device 210 and then reapplied, the contents of the non-volatile memory 214 remain in tact, whereas the contents of the volatile memory 216 are lost, corrupted, or erased.

The computing device 210 may access one or more external display devices 230 such as a CRT monitor, LCD panel, LED panel, electro-luminescent panel, or other display device, for the purpose of providing information or computing results to a user. In some embodiments, the external display device 230 may actually be incorporated into the product itself. The processing unit 212 interfaces to each display device 230 through a video interface 220 coupled to the processing unit 212 over the system bus 218.

The computing device 210 may send output information, in addition to the display 230, to one or more output devices 232 such as a speaker, modem, printer, plotter, facsimile machine, RF or infrared transmitter, computer or any other of a variety of devices that can be controlled by the computing device 210. The processing unit 212 interfaces to each output device 232 through an output interface 222 coupled to the processing unit 212 over the system bus 218. The output interface 222 may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The computing device 210 may receive input or commands from one or more input devices 234 such as a keyboard, pointing device, mouse, modem, RF or infrared receiver, microphone, joystick, trackball, light pen, game pad, scanner, camera, computer or the like. The processing unit 212 interfaces to each input device 234 through an input interface 224 coupled to the processing unit 212 over the system bus 218. The input interface 224 may include one or more of a variety of interfaces, including but not limited to, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 214, the volatile memory 216, or in a remote memory storage device accessible through the output interface 222 and the input interface 224. The program modules may include an operating system, application programs, other program modules, and program data. The processing unit 212 may access various portions of the program modules in response to the various instructions contained therein, as well as under the direction of events occurring or being received over the input interface 224.

The computing device 210 may transmit signals to, or receive signals from, one or more communications systems 236 such as a cellular network, RF network, computer network, cable network, optical network or the like. The processing unit 212 interfaces to each communications system 236 through a transmitter 226 and a receiver 228, both coupled to the processing unit 212 over the system bus 218. The transmitter 226 and the receiver 228 may include one or more of a variety of transmission techniques such as a radio frequency interface (AM, FM, FSK, PSK, QPSK, TDMA, CDMA, Bluetooth or other technique) or an optical interface such as infrared or IrDA.

Electronic Whiteboard Operation

Another embodiment of the present invention provides a method of operating electronic whiteboard systems that reduces reliance on window-based menu navigation, is less complex than existing methods, and reduces the image clutter on electronic whiteboard surfaces. An exemplary method of operating such an electronic whiteboard system can include a software application.

For example, the electronic whiteboard system 100 of Fig. 1 can detect input, such as pressure from touches, marking, drawing, or writing on surface 135. The detected input can be converted into location values and electronically reproduced. The electronic reproduction can be projected onto area 140 of surface 135 printed for later reference, or saved to disk. Electronic whiteboard system 100 can detect input, for example ink strokes from a dry-erase marker, or can identify and reproduce individual characters, symbols, words, or phrases.

Input, such as writing strokes, can be captured in real time, for example during writing on surface 135. In one embodiment, input is obtained from surface 135 and converted to (x,y) pairs and associated with a color if a color is specified. The data can be stored in vector format so that a copy of the input from surface 135 can be electronically re-created at a variety of output resolutions.

Electronic whiteboard system 100 can be operated in at least two modes: ink capture and projection. In ink capture, writing on the electronic whiteboard 105 is saved onto the memory of the computing device 210 memory for later reproduction. In projection, an image is projected on the electronic whiteboard from a computer, and it can be manipulated through one of two minor modes: Point or Draw. In projection-only mode, system 100 will not identify input from surface 135 as writing or drawing data. In data-capture mode, system 100 will identify input from surface 135 as writing or drawing data. Point mode allows a stylus or touch to the drive the cursor of the computing device 210, click icons, etc. Draw mode adds virtual ink to the projected image.

Ink capture and projection modes can be active at the same time, but different in physical locations of the board. For example, surface 135 can have an area 140 designated for projection of images and another area designated for ink capture. Images projected onto surface 135 can be aligned using an alignment protocol, for example to demark projected image area 140. The alignment protocol can project an alignment image onto surface 135 and request a user to demark the area of the image, for example by touching at least two opposite corners of the image. In another embodiment, all four corners of the projected image can be touched to demark projected area 140. System 100 can differentiate between input received in area 140 (projection) versus input received outside of area 140 (data-capture). Within the projection area, point and draw can be mutually exclusive. However, the processing device 115 can capture ink, virtual ink, and the projected image all at the same time.

Once area 140 has been aligned to a projected image, a cursor of processing device 115 can be manipulated from surface 135 by, for example, tapping or dragging a stylus across surface 135, preferably in area 140. Some electronic whiteboards can detect the difference between a stylus (or finger) and marker. In these systems, moving a stylus across area 140 can cause the projected image of the cursor to move directly under the stylus. Moving the stylus along surface 135 outside area 140 results in a relative cursor move. Stroking surface 135 outside of area 140 in one direction operates similar to stroking a mouse in one direction, and the cursor continues to move in a straight line. Although normally producing left-clicks, electronic whiteboard system 100 can also emulate mouse right-clicks by pressing a stylus against surface 135 for a time, and releasing. One to three seconds is optimal.

Using a remote control device in combination with direct input into an electronic whiteboard can reduce visual clutter typically associated with existing electronic whiteboard systems, for example, by eliminating the need for tool box menus for software applications, or by utilizing a form of faceless software, wherein one looking at the whiteboard would be unaware that software is running, as no windows or like displays would be evident on the whiteboard.

The faceless software can start when the operating system is booted, before any password dialog boxes may appear. The software can remain in the background as long as the computer 210 is powered on and can quietly make connection with electronic whiteboard 105 when the electronic whiteboard 105 is turned on or hot-plugged. A message balloon (or non-model dialog box on older operating systems) can briefly appear when connection is made or lost.

A system tray (as used with Windows) or a menu bar (as used with Macintosh OS) icon can be the only visible on-screen display during operation. The icon visually indicates the connection status of electronic whiteboard 105. Clicking on this icon displays a short menu that allows the user to exit the software or to configure it by setting software properties.

Users can change software options of the faceless software by clicking on an icon in the system tray or menu bar and choosing Configure… from the popup menu. The dialog box can have an OK, Cancel, Apply, and Help button. The software properties are organized in tabs for clarity. At the bottom of each tab can be a Restore Defaults button, which restores the factory setting for that tab.

The faceless software can support various types of interaction, including capturing writing in ink on electronic whiteboard 105, controlling the cursor of computing device 210 from electronic whiteboard 105 by pointing to a projected image, and marking up the image projected on electronic whiteboard 105 with virtual ink, as described herein.

The faceless software can support multiple electronic whiteboards and/or multiple monitor computer configurations by using a unique USB serial number, which each USB device carries.

The faceless software can also support third-party integrators at two separate interface levels. At one level, raw coordinates and other data from electronic whiteboard 105 can be sent to an application such that the third-party application can decide how to interpret the removal of pens, and button presses on the remote control devices 130. At the second level, detailed stroke information (qualified with the current pen color and thickness or eraser type) can be sent.

The format of both streams can be device independent, wherein the interface can be the same regardless of what kind of electronic whiteboard 105 is being used.

The faceless software can be provided on a CD-ROM or a USB key drive which is compatible with Windows and Macintosh platforms.

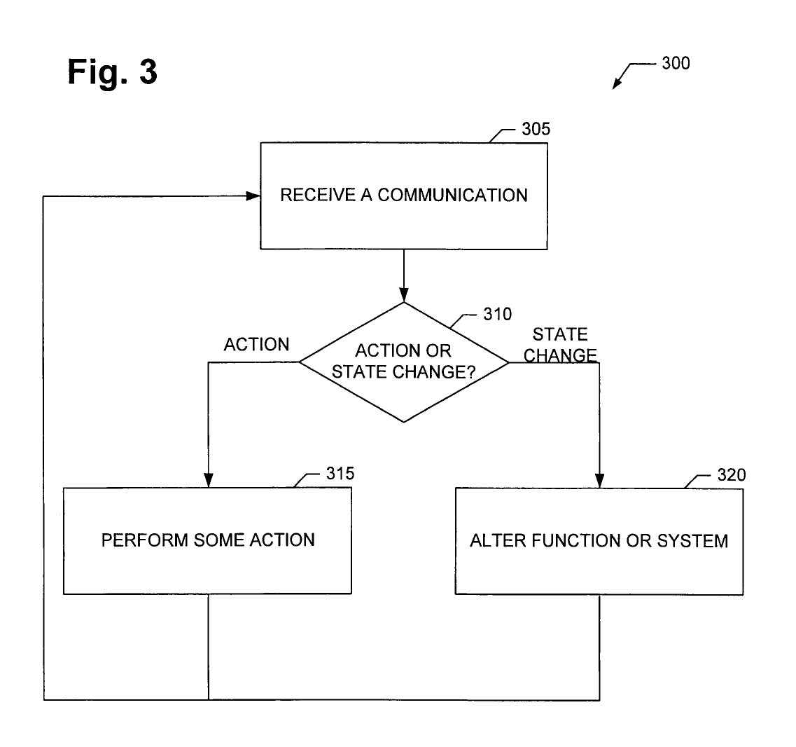

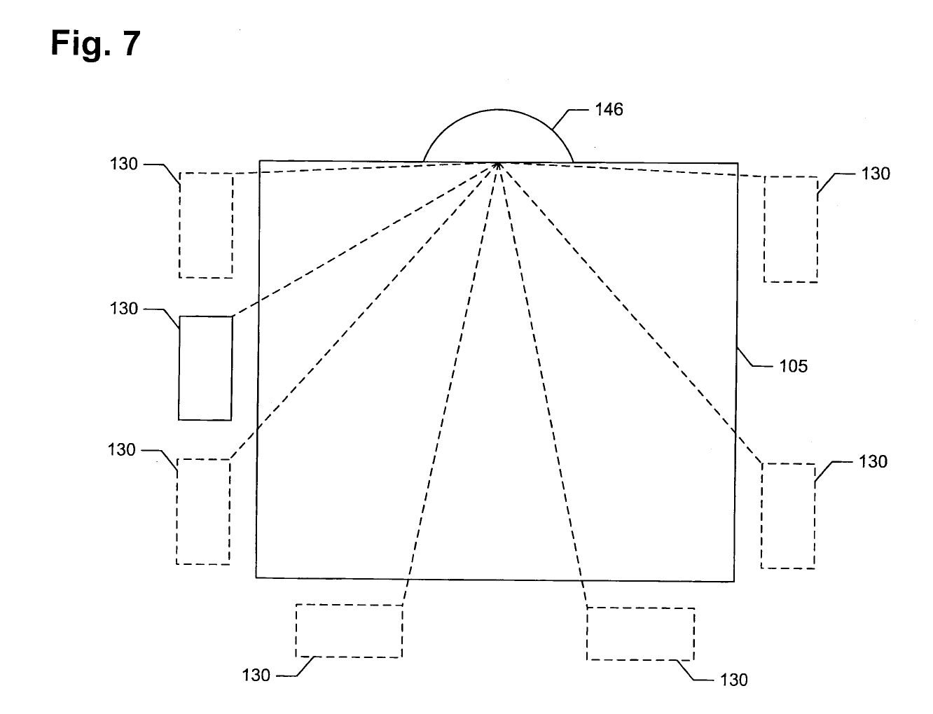

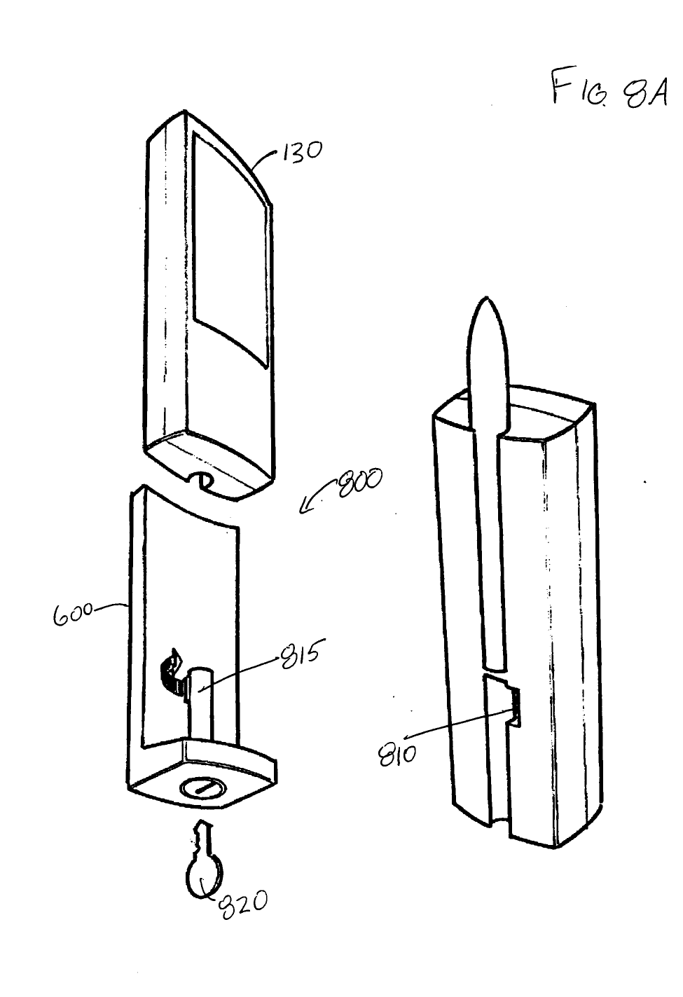

Fig. 3 is a block diagram of an exemplary process 300 for operating electronic whiteboard system 100 using a remote control device. In step 305, electronic whiteboard system 100 receives a communication, for example from remote control device 130. Any component can receive the communication, but a receiving device 146 (Fig. 7) typically will receive the communication and relay the communication to the processing device 115, if necessary. The communication can be a signal from a transmitting device or a signal resulting from the touch of a touch sensitive surface of electronic whiteboard 105. The signal can be an electromagnetic signal, for example an infra red signal or a laser light signal. Alternatively, the signal can be a radio signal or voice command.

In response to receiving the communication, the electronic whiteboard system 100 determines whether the communication requests an action or a state change at step 310. If an action is requested, then in step 315, the electronic whiteboard system 100 performs an action. The action can include print, save, erase, next page, previous page, click, move cursor, or other actions. If a state change is requested, then in step 320, a set of instructions can be a command function that can alter the function of electronic whiteboard system 100. Altering the function includes initiating, terminating, or maintaining a function of electronic whiteboard system 100. Exemplary functions include, but are not limited to, changing the color, changing line style, entering projection mode, leaving projection mode, changing line width, and toggling between point and draw. The function can be a function of a software application or operating system running on electronic whiteboard system 100.

In a preferred embodiment, the method of operating electronic whiteboard system 100 combines receiving communications from a touch sensitive electronic whiteboard surface and a remote control device 130.

Operating electronic whiteboard system 100 preferably is accomplished without using projected windows, toolbars, menus, dialog boxes, status bars, or tool boxes for controlling whiteboard functions, etc. Instead, remote control device 130 is actuated to control specific functions. Incorporating physical input with remote input reduces the need for windows, toolbars, menus, dialog boxes, status bars and tool boxes to operate the system.

Remote Control Device

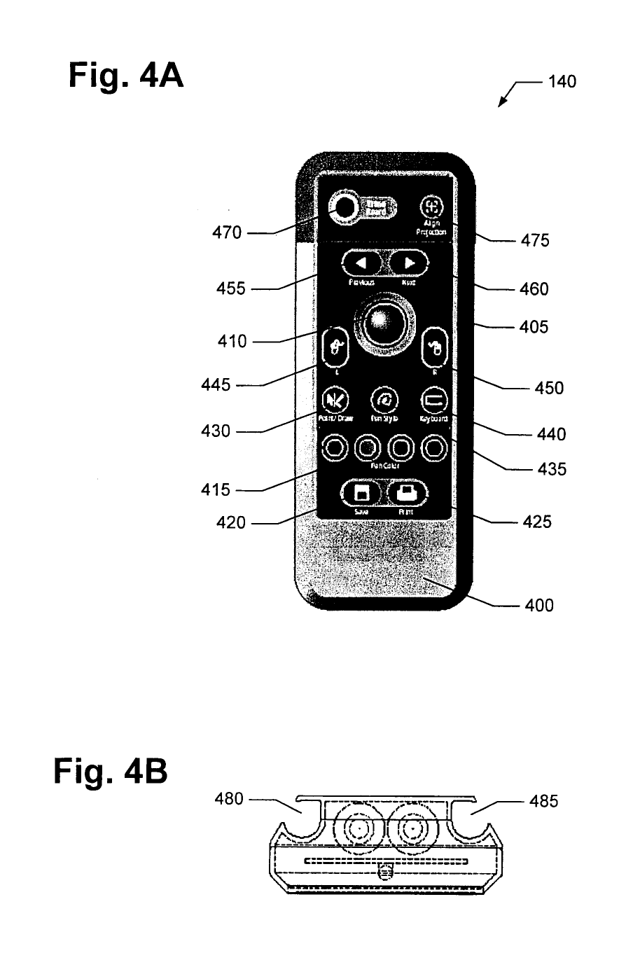

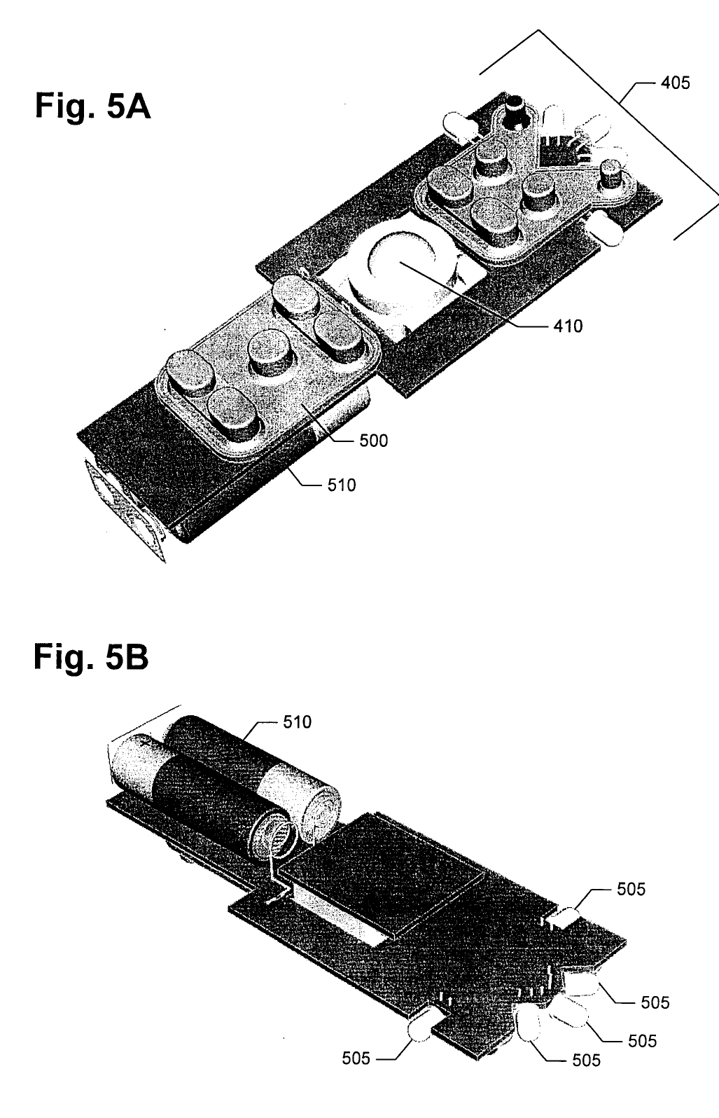

Figs. 4A, 4B, 5A and 5B depict an exemplary remote control device 130 of one embodiment of the present invention. Remote control device 130 can assist a user in navigating or operating application software of electronic whiteboard system 100 without the need for touching electronic whiteboard 105 or processing device 115. Remote control device 130 can actuate various functions traditionally presented to a user in a projected tool bar, and when combined with input received via electronic whiteboard surface 135, processing device 115, or a combination thereof, forms an exemplary operating system and method for operating electronic whiteboard system 100 that avoids the need for projected windows or toolbars. A user can actuate a control function using remote control device 130, for example pen color, and input received via electronic whiteboard surface 135 can be electronically represented in the selected color.

Remote control device 130 comprises a body portion 400. The body portion 400 can include an exterior shell encasing components of remote control device 130 including for example, a processor, preferably a microprocessor, a transmitting device 405, a power source 510, a trackball assembly 410, and actuator assemblies 500. An infrared transmissive window encloses the transmitting device(s) 405.The shell casing can be made from durable material, including but not limited to polymers such as plastic, polycarbonate, thermoplastics, or metal. Remote control device 130 can be adapted to receive a stylus or a dry-erase marker. For example as shown in Fig. 4B, remote control device 130 can include a recesses 480 and 485 along a side of body portion 400 fitted to cooperate with a stylus for use with electronic whiteboard 105. The stylus can slide into recess 480 or matingly engage remote control device 130 via recesses 480 or 485.

Remote control device 130 can include a plurality of actuators for actuating a function of electronic whiteboard system 100. The actuators can be a physical button, switch, trigger, toggle switch, trackball, or similar device that can control a function of the electronic whiteboard system 100. When an actuator of remote control device 130 is actuated, a signal is communicated from remote control device 130 to electronic whiteboard system 100, or a component thereof. For example, the signal can be transmitted to electronic whiteboard 105, processing device 115, projecting device 125, or to receiving device 146. As shown in Fig. 7, receiving device 146 can be in communication with electronic whiteboard 105 or any component of electronic whiteboard system 100. When receiving device 146 receives a signal from remote control device 130, receiving device 146 can relay the signal, for example, to processing device 115, if necessary, to control a function of electronic whiteboard system 100. The signal can be electromagnetic, infrared, or laser, or can be a radio signal.

Remote control device 130 can control functions relating to projected images or to information input into electronic whiteboard system 100 via electronic whiteboard 105. For example, remote control device 130 can control positioning of a cursor of an operating system or software application running on electronic whiteboard system 100. The cursor can be projected onto electronic whiteboard 115. In one embodiment, remote control device 130 can include trackball 410. Actuating trackball 410 causes a cursor or similar icon to move about projected area 140 or for example, a graphical user interface of processing device 115. The graphical user interface can be projected onto a surface 135 of electronic whiteboard 105. Thus, if an operating system application such as Windows^{®} or Macintosh^{®}OS or the like is running on processing device 115, the cursor can be moved using trackball 410 and left and right click buttons 445 and 450 pressed to navigate through menu items or to select items in the operating system. Thus, a user of electronic whiteboard system 100 can use trackball 410 to remotely navigate through a software application running on the computer 115. Rolling trackball 410 in any direction can cause the cursor of the operating system or software application to move in a specific corresponding direction.

Remote control device 130 can also be used to control pen color. Buttons 415 can be used to select, change, or modify the color of information collected by electronic whiteboard 105. For example, electronic whiteboard system 100 can project an image onto an area of surface 135. The image can be annotated by touching surface 135 under the projected image. Electronic whiteboard system 100 can then display or project the annotated information in a color selected by actuating button 415. Annotations can occur in real time, and can be displayed or projected in any color including, for example, black, red, blue, green, yellow, or a combination thereof. The color buttons 415 can also be used to indicate to the electronic whiteboard system, the color of dry-erase pen currently being employed to mark on the whiteboard surface 135 during ink capture mode.

Button 420 can be used to save information projected on electronic whiteboard 105 or captured by electronic whiteboard 105. For example, a user can mark on the surface of electronic whiteboard 105 using a writing implement such as a dry-erase felt tipped marker. The marker leaves physical indicia of information on surface 135. Electronic whiteboard system 100 can electronically capture the physical indicia of information from surface 135, for example by using conventional resistive membrane technology. Additionally, electronic whiteboard system 100 can project an image onto an area 140 of surface 135. The projected image can include textual, graphical, symbolic information or a combination thereof. The projected image can also be annotated by the user. Actuating button 420 causes a file containing information corresponding to the physical indicia written on surface 135 and projected onto area 140 to be electronically generated and optionally stored to a memory device. Actuating button 425 sends the same image to a printer connected to computer 115. This file is similar to a Snapshot taken of surface 135. If no writing or marks have been made outside area 140, the file contains only the projected information including any annotations to the projected information. The file can also save any annotations added to a projected image.

The file can be generated using conventional file formats such as JPEG, PDF, or TIFF file formats. Images saved in compressed JPEG or TIFF formats are bitmaps. When saved as PDF format files, the computer screen images are also bitmaps. Any annotations to the images made electronically or physically can be rendered in vector format to overlap the screen image. Thus, using button 420 a user can cause a file to be generated that contains all of the information on surface 135 whether the information is projected onto the surface, physically placed on the surface, or captured in response to a touch surface 135 or a combination thereof. Additionally, the data can be stored in a vector format that can be printed at a high resolution.

Actuation of remote control 130 can be associated with indicia to indicate a function. Button 425 can include a printer icon indicating that button 425 controls a printing device or printing function. Actuating button 425 can cause a signal to be transmitted to electronic whiteboard system 100, or a component thereof, resulting in the printing of information or data. The data can be written, drawn, marked, or otherwise input into electronic whiteboard system 100. For example, printed information can include data input via a surface of electronic whiteboard 105, projected on a surface of whiteboard 105, displayed on monitor 120, or a combination thereof.

Remote control device 130 can also control functions relating to a projected image, for example an image projected on surface 135. Typically, an image corresponding to a graphical user interface of processing device 115 is projected onto area 140 of electronic whiteboard 105 to permit a user to operate processing device 115 through inputs into area 140 of electronic whiteboard 105. In one embodiment, area 140 comprises less than half the area of surface 135.

When surface 135 is a touch sensitive surface using, for example, resistive membrane technology, a user can select and navigate through a projected image of a graphical user interface or software application by touching the surface corresponding to the projected image of the graphical user interface in area 140. The area of surface 135 that is outside area 140 is typically used for writing or drawing with a writing implement, for example a dry-erase marker.

Button 430 can be used to toggle between operating modes for projected image areas of surface 135. For example, actuating button 430 a first time can select a command mode, referred to as Point mode. Actuating button 430 again can select an input mode, referred to as Draw mode. Repeatedly actuating button 430 can toggle between at least two operating modes, for example Point mode and Draw mode. It will be appreciated that button 430 can be used to toggle between any number of operating modes.

When a command mode such as Point mode is selected using button 430, electronic whiteboard system 100 will interpret input through surface 135 in projection area 140 as selecting an item or data. Point mode enables simulating mouse clicking, double-clicking, and dragging using a stylus. In Draw mode, electronic whiteboard system 100 will interpret input through surface 135 in projection area 140 as annotations (or mark-ups). For example, in Draw mode a touch of surface 135 would result in electronic whiteboard system 100 electronically generating an image corresponding to the area touched, for example a line or drawing.

When a user is working in area 140 with a projected image, the user may desire to select a menu item, for example a function in a menu of a projected graphical user interface, by touching the surface of the electronic whiteboard under the projected image. To insure that electronic whiteboard system 100 interprets the touch as selection, button 430 can be actuated to place electronic system 100 in Point mode. Once in Point mode, a user can, for example, move a projected image of a cursor in area 140 by dragging his finger or a stylus across the surface of the electronic whiteboard under the projected image. The system will not generate a graphical representation of the path the finger or stylus unless the system is in Draw mode. Actuating button 430 again, toggles the system into Draw mode. In areas of surface 135, outside area 140, ink is always captured as ink, regardless of the Point / Draw mode.

Button 435 can control pen style, for example, pen style for electronically producing data captured through a touch sensitive surface 135. Selecting button 435 can cause the image of a palette to be projected onto area 140. The palette can contain a number of drawing tool types, colors, tool thickness, and other formats to characterize the electronic annotation captured through a touch sensitive surface 135. For example, line width, or formats such as dotted or dashed line can be selected by touching a touch sensitive surface 135 underneath to the projected image representing the desired pen characteristic. Once selected, subsequent data captured via the surface of electronic whiteboard 105 will be formatted accordingly. The palette image disappears after a tool or format has been selected. Dragging on the non-button areas of the palette allows the user to move it on the projection surface 140. Touching surface 135 outside the area of the projected palette will cause the palette to disappear with no change to current format selection.

Button 440 controls the projection of the image of a keyboard, for example an alpha numeric keyboard, onto surface 135, preferably in area 140. Alternatively, if electronic whiteboard system 100 has an existing keyboard, the existing keyboard is launched. Touching letters or numbers of the projected keyboard will input the corresponding letters or numbers into electronic whiteboard system 100 at the current text cursor. For example, a internet address can be entered into a selected field of a web browser application projected onto surface 135 by touching the corresponding letters or numbers on the projected keyboard. Activating button 440 again will cause the projected keyboard to disappear or inactivate an existing keyboard. Dragging on the non-button areas of the palette allows the user to move it on the projection surface 140.

Remote control device 130 can optionally include buttons 445 and 450 that can be actuated to simulate left and right mouse button functions respectively. For example, button 445 can be used with a projected graphical user interface to select an item including activating a pop-up menu or button 445 can be pressed twice rapidly to generate a double-click. Button 450 can cause a tool box menu or a list of specific functions to be projected on the surface 135.

Buttons 455 and 460 can be actuated to control a projected image by causing the previous image to be displayed or advancing to the next image respectively. For example, a slide show presentation can be projected onto surface 135, for example in area 140. Actuating button 455 will cause the previous slide to be displayed, and actuating button 460 will cause the next slide to be displayed. Alternatively, previous pages or next pages of menu lists, web pages, or software applications can be activated accordingly.

Button 470 controls erasing electronic information stored in electronic whiteboard system 100. Selecting button 470 causes the system to clear information in a memory device, for example an internal memory device. Button 470 can be used to clear electronically captured ink drawings as well as virtual electronic annotations.

Images projected onto surface 135 can be aligned using an alignment function of button 475. Selecting button 475 can initiate an alignment protocol to align a projected image and demark projected image area 140. The alignment protocol can project an alignment image onto surface 135 and request a user to demark the area of the image, for example by touching at least two opposite corners of the image. In another embodiment, all four corners of the projected image can be touched to demark projected area 140. By indicating the borders of area 140 the system can differentiate between input received in area 140 versus input received outside of area 140. Additionally, the electronic whiteboard system can compensate for optical or image distortions caused by a projector using information obtained during the alignment protocol.

Figs. 5A and 5B are illustrations of a top and bottom view respectively of an internal component of remote control device 130. Transmitting device 505 can be placed on a first end of remote control device 130 for transmitting a signal to electronic whiteboard system 100, for example to receiving device 140. Transmitting device 505 can be a light emitting diode (LED), for example an infra red emitting diode; however, transmitting device 505 can transmit any electromagnetic or radio signal for controlling a function of electronic whiteboard system 100.

Remote control device 130 can include a plurality of transmitting devices 505. Transmitting devices 505 can be positioned on one, two, three or four sides of remote control device 130, preferably transmitting devices 505 are placed on three contiguous sides. Transmitting devices 505 can be placed along the sides of remote control device 130 so that a signal from remote control device 130 can be received by electronic whiteboard system 100 when remote control device 130 is mounted on a vertical edge of electronic whiteboard 105. Transmitting devices 505 can be powered by a power supply 510, preferably a battery power supply.

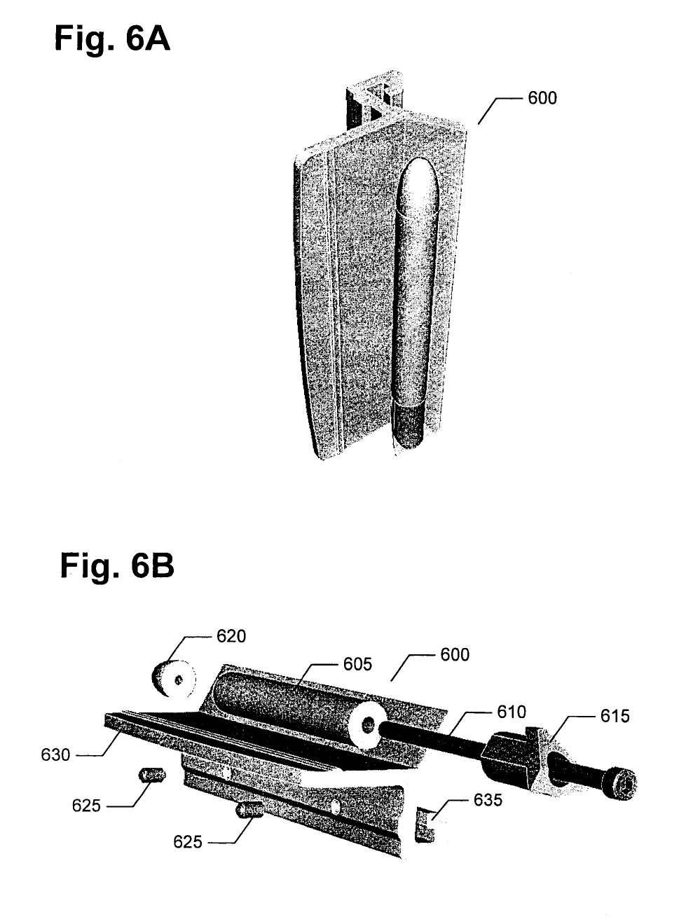

Remote control device 130 can be mounted on a edge of electronic whiteboard 105, preferably a vertical edge, using a mounting bracket 600 or clip depicted in Figs. 6A, 6B. Mounting bracket 600 can attach to electronic whiteboard 105 via a curved lip 635 adapted to receive an edge of electronic whiteboard 105. Fasteners 625 can be inserted through mounting bracket 600 abutting a portion of electronic whiteboard 105 and thereby clamping the mounting bracket 600 to the portion of electronic whiteboard 105 between fasteners 625 and curved lip 635. Piston 610 can be used to assist in positioning mounting bracket 600 at a location along an edge of electronic whiteboard 105. Docking element 630 extends out from mounting bracket 600. In one embodiment, body portion 400 of remote control device 130 is adapted to receive docketing element 630 of mounting bracket 600. For example, body portion 130 can include a recess 480 or 485 (Fig. 4B) along a side or remote control device 130 wherein the recess is fitted to docking element 630. The recess 480 of remote control device can matingly engage docking element 630. The remote control device 130 could be placed at a number of locations along a vertical or horizontal edge of the electronic whiteboard 105, as shown in Fig. 7, on mounting bracket 600. The mounting bracket 600 can be loosened and slid vertically along either side or alternatively positioned along the bottom edge of the electronic whiteboard 105. Extra transmitting devices 505 can be positioned so as to allow the receiver unit 146 to receive an infrared signal from remote control device 130, regardless of where along the perimeter it is placed.

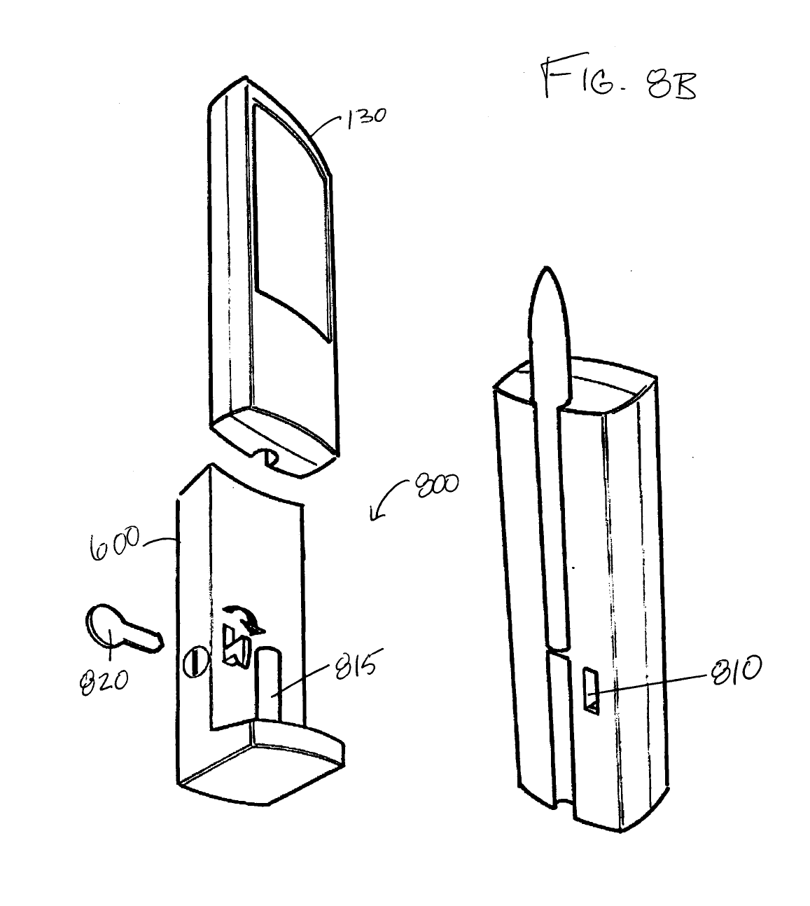

Alternatively, remote control device 130 can have a single slot for mounting on mounting bracket 600 and for holding a stylus, as depicted in Figs. 8A and 8B. Figs. 8A and 8B also show a locking mechanism 800 for remote control device 130. Typically, teachers need to maintain control of their peripherals, and a locking mechanism allows them to secure the remote control device 130 to the mounting bracket 600. Remote control 130 can have an opening 810, for example a slot, keyhole, channel, or another mechanism, for accepting a locking tab 815. A key 820, inserted in the bottom of locking tab 815 engages locking tab 815 and rotates locking tab 815 in opening 810, thereby securing remote control device 130 from removal. Key 820 could be a metal, plastic, rubber, glass, or other material and does not necessarily need to activate tumblers in locking mechanism 800.

For example, opening 810 can be located on the back of remote control device 130. On mounting bracket 600, a slot can be located near the top of an alignment pin. On the back side of mounting bracket 600, a spring with two wedge shaped steps can pass through the slots in the mounting bracket 600. When remote control device 130 is slotted into mounting bracket 600, the spring"s wedged shaped steps can be pushed back until they reach the opening 810 in the back of the remote control device 130. The wedged-shaped steps will click into opening 810 in the remote control device 130 and lock it to the mounting bracket 600. To release the remote control device, key 820 can be inserted into the bottom or a side of the mounting bracket 600. Key 820 can push the spring back and away from the remote control device 130 and can disengage the steps of the spring passing through mounting bracket 600. Additionally, key 820 can be secured in place for any duration of time such that remote control device 130 can be repeatedly removed and replaced without the unlocking it each time.

The electronic whiteboard system 100 of the present invention can optionally include conventional peripheral components, including but not limited to a printer, scanner, memory storage device, transmitting device, receiver, eraser, stylus, or additional electronic whiteboard systems. The components of the electronic whiteboard system 100 of the present invention can be operatively connected using conventional wiring, wireless technology, fiber optics, satellite technology, internet, intranet, infra red technology, or radio technology.

Electronic whiteboard system 100 can include indicators that can inform a user when a particular feature or function is in operation. The indicators can be a colored light, preferably a Light Emitting Diode (LED). For example, a red indicator can glow when system 100 believes physical data is on surface 135, for example writing or drawing. A yellow indicator can be used to indicate when system 100 is in Draw mode versus Point mode. Finally, another colored indicator can be used in indicate when system 100 is in projection mode and/or during an alignment protocol.

Yet another optional feature can be the use of a USB key drive that stores the software that drives the electronic whiteboard 105. A USB key drive is a portable storage device that plugs into any USB port and functions like a hard drive. Currently, a USB key drive can have 16, 32, 64, 128, 256, or 512 MB of disk space. Any USB key drive, which is commercially available, can be used. When the USB key drive is plugged into a USB port of the processor 115, the USB key drive functions as a hard drive.

In an exemplary embodiment, the USB key drive is secured to the end of the USB cable that connects the electronic whiteboard 105 to the processing device 115. For example, the USB key drive can be secured to the existing USB cable by a plastic or rubber overmold or by a zip tie. Alternatively, the USB key drive can be secured to the existing USB cable by any other means. By securing the USB key drive to an existing USB cable, users cannot inadvertently take the USB key drive with them. Thus, in either embodiment, the USB key drive remains readily available for use by subsequent users.

When the USB key drive is connected to the processing device 115, the user can double click on a set-up program such that applications used to drive the electronic whiteboard can be installed on the processing device 115. In another embodiment, the USB key drive can be configured such that the set-up automatically begins the installation process. In yet another embodiment, the USB key drive can be embedded into the electronic whiteboard 105 so that a single USB cable connected the whiteboard and the processing device 115.

Other optional elements can be added to the USB key drive. For example, the USB key drive can be attached to a fob. Attached to the fob can be card with brief user instructions for using the USB key drive. For example, a short three step process can be included on the card, wherein the first step is to connect the USB key drive to the USB port of the processor, the second step is to double click on the installation software on the USB key drive, and the third step is to disconnect the USB key card from the USB port and connect the existing USB cable from the electronic whiteboard to the USB port of the processor. The instructions could also be located on the key drive itself.

It will be appreciated that various modifications may be made to the invention as described without departing from the spirit of the invention or the scope of the appended claims.

What is Claimed is:

1. What is claimed is
1. In an electronic whiteboard system including an electronic whiteboard, an improvement to the electronic whiteboard system comprising a remote control device for remotely controlling an operation of the electronic whiteboard system, the remote control device incorporating a transmitter for transmitting a signal to the electronic whiteboard system, the remote control device further incorporating at least one actuator that when selected, triggers the transmission of the signal to the electronic whiteboard system.
2. The improved electronic whiteboard system of Claim 1, the remote control device comprising a body portion adapted to receive a stylus.
3. The improved electronic whiteboard system of Claim 1, the remote control device comprising a body portion adapted to receive a mounting bracket, the mounting bracket designed to mount the remote control device in proximity to the electronic whiteboard.
4. The improved electronic whiteboard system of Claim 3, the body portion of the remote control device adapted to receive a locking mechanism for locking the remote control device to the mounting bracket.
5. The improved electronic whiteboard system of Claim 1, wherein the operation of the electronic whiteboard system by the remote control device is selected from the group consisting of pen color, print, save, pen style, keyboard, point, draw, erase, align, next image, cursor position, or previous image.
6. The improved electronic whiteboard system of Claim 1, the remote control device further comprising at least a first transmitter positioned on a first side of a body portion of the remote control device, and a second transmitter positioned on a second side of the body portion.
7. The improved electronic whiteboard system of Claim 6, wherein the first transmitter is positioned perpendicular to the second transmitter.
8. The improved electronic whiteboard system of Claim 1, the electronic whiteboard comprising a touch sensitive surface.
9. The improved electronic whiteboard system of Claim 8, the touch sensitive surface comprising two conductive sheets physically separated from each other, the sheets capable of contacting one another in response to a touch, such contact between the sheets resulting in a detectable change in at least one of voltage or resistance.
10. The improved electronic whiteboard system of Claim 1, the electronic whiteboard comprising a laser-tracking surface.
11. An electronic whiteboard system comprising:
an electronic whiteboard;
a remote control device for communicating a signal with the electronic whiteboard, wherein the signal causes a set of instructions to be executed by the electronic whiteboard system; and
a communicating device operatively connected to the electronic whiteboard for communicating the signal with the remote control.
12. The electronic whiteboard system of claim 11, wherein the remote control comprises a body portion, the body portion having a transmitting device for transmitting data to the electronic whiteboard system and at least one function key that when selected, causes the transmission of data to the electronic whiteboard system for remotely controlling an operation of said electronic whiteboard system.
13. The electronic whiteboard system of claim 12, wherein the transmitting device comprises an infrared light-emitting diode.
14. The electronic whiteboard system of claim 11, wherein the electronic whiteboard comprises a button on a surface of the electronic whiteboard that when physically selected, controls a function of the electronic whiteboard system.
15. The electronic whiteboard system of claim 11, wherein said remote control device is adapted to receive a stylus.
16. A method of operating an electronic whiteboard system, the method comprising:
receiving a communication from a remote control device; and
executing a set of instructions in response to receiving the communication, wherein the set of instructions alters a function of said electronic whiteboard system.
17. The method according to Claim 16, wherein the function of the electronic whiteboard system comprises a function of an application program.
18. The method according to Claim 16, wherein the function is selected from the group consisting of pen color, print, save, pen style, keyboard, point, draw, erase, align, next image, cursor position, and previous image.
19. The method according to Claim 16 further comprising the step of running faceless software.
20. The method according to Claim 16 further comprising the step of providing a USB key drive to store software driving the electronic whiteboard system.
